(19) United States
(12) Patent Application Publication
(10) Pub. No.: US 2021/0387871 A1
(43) Pub. Date: Dec. 16, 2021

(54) PORTABLE WATER PURIFYING AND DISPENSING UNIT

(71) Applicant: VWS (UK) LIMITED, High Wycombe Buckinghamshire (GB)

(72) Inventors: Nigel EMERY, Monks Risborough Buckinghamshire (GB); Lee UNDERWOOD, High Wycombe Buckinghamshire (GB)

(73) Assignee: VWS (UK) LIMITED, High Wycombe Buckinghamshire (GB)

(21) Appl. No.: 17/283,124

(22) PCT Filed: Oct. 24, 2019
(86) PCT No.: PCT/GB2019/053025

§ 371 Date: Apr. 6, 2021

(30) Foreign Application Priority Data
Nov. 1, 2018 (GB) 1817874.9

(51) Int. Cl. C02F 1/42

(52) U.S. Cl. CPC C02F 1/42; C02F 2103/026

(57) ABSTRACT

A hand-holdable portable water purifying and dispensing unit is described comprising at least a housing, a purified water inlet, a further-purified water dispense outlet, a dispense operator, a reservoir, one or more water further-purification devices, and an internal water recirculation pump and pathway, said pathway including the reservoir and the one or more water further-purification devices. Optionally, the reservoir has a volume in the range 100 ml to 2000 ml, preferably in the range 200 ml and 1000 ml.

The present invention relates to a portable water purifying and dispensing unit, unit and base assembly, and unit and base and/or water source combination, particularly but not exclusively for laboratory and medical grade water.

Water purification apparatus and units for use in laboratories and healthcare facilities are well known. Generally they involve the reduction and/or removal of contaminants and impurities to very low levels. They typically contain a variety of technologies that remove particles, colloids, bacteria, ionic species and organic substances and/or molecules.

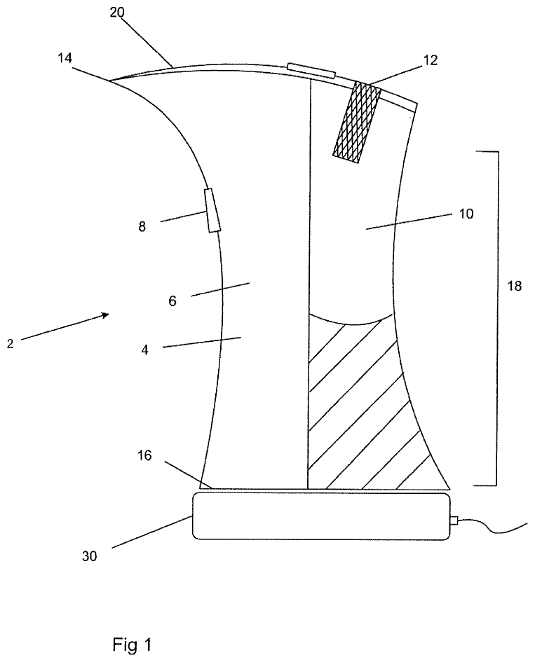

Conventionally, water purification apparatus are complete one-piece units, in fixed positions within a laboratory, either on a floor, wall or bench or under a bench, having a fixed point of dispense and all parts or components and controls and operations housed within a single housing. An example is shown in FIG. 1 of our WO03/076342A1.

But to maintain a reservoir of ‘ultra-purified’ water, (generally having a conductivity of less than 1 μS/cm, such as less than 0.1 μS/cm or even less than 0.067 μS/cm, at 25° C.), that is immediately available for dispense and use, requires such water to be constantly or near-constantly purified. This is typically achieved by recirculation of the already purified water in a reservoir through the water purification apparatus in the housing.

US 2006/0191829 A1 shows a proposed water dispensing device for dispensing water at a location that is a small distance beyond the actual water purification unit using a connected dispensing gun. The dispensing gun is connected by tubing and control wires to the water purification unit.

Meanwhile, traditional water dispensers that can be used remotely from a water source, such as a workbench, are ‘squeezable’ water bottles known in any laboratory. They are readily and quickly movable around the laboratory and they are holdable and operable with a single hand, so that the other hand can be used to hold the beaker or other object that is the recipient or target for the water being dispensed. Such bottles do not have any water-purification technologies, and so any purified water therein rapidly becomes contaminated with ionic, organic and microbiological contaminants from the air or any surfaces which are in contact with the water.

An object of the present invention is to provide independent high purity water dispense.

Thus, according to one aspect of the present invention, there is provided a hand-holdable portable water purifying and dispensing unit comprising at least a housing, a purified water inlet, a further-purified water dispense outlet, a dispense operator, a reservoir, one or more water further-purification devices, and an internal water recirculation pump and pathway, said pathway including the reservoir and the one or more water further-purification devices.

In this way, a user can use the unit of the present invention at any suitable location that is independent and remote from, and not physically tied to, a source of purified water. The unit provides a portable reservoir of water such as ultra-purified water, available for immediate use as a further-purified water stream.

The unit of the present invention comprises at least a handheld housing. The term “handheld” as used herein relates to being holdable by a human hand, optionally by either human hand.

Preferably, use or operation of the unit is achievable by the same hand holding the housing. Alternatively operation may be enacted by electronic communication from a remote unit or device, such as a computer, tablet or mobile phone, or by detection from a proximity sensor.

Housings designed to be handheld housings are known in the art, and are not further described herein.

Preferably, the size, shape and design of the housing allows the unit to be gripped and carried by or in one human hand, and preferably operable or capable of operation for the dispense of water by the same human hand.

Preferably, the housing has a partial or substantial outer surface or coating which is designed or adapted to be gripped by a human hand. Alternatively or additionally, the unit includes a handle, optionally separable or integral with the housing, to allow it to be gripped, carried and/or operated by a human hand.

Optionally, the housing comprises an elongate body having a base, generally a wholly, substantially or at least partly flat base, an upstanding reservoir, a top part or surface, having the purified water inlet, and a further-purified water dispense outlet extending outwardly and/or laterally from the body.

Optionally, the unit of the present invention is at least partly transparent. Optionally, the housing includes one or more transparent portions and one-or more non-transparent portions. A non-transparent portion may house one or more components or parts of the unit of the present invention, including but not limited to at least part of the internal water re-circulation pathway.

Optionally, a non-transparent portion of the housing includes a water re-circulation outlet at or near the top of the non-transparent portion, and a water re-circulation inlet at or near the bottom of the non-transparent portion that are designed to connect with an inlet and outlet of the reservoir.

Optionally, the elongate body has at least one curved surface around which a human hand can be located. Optionally, at least a partial extent of the elongate body between the base and the top surface has a circular or elliptical or otherwise arcuate cross-section, around which the hand and fingers of a human can easily locate. Optionally, the unit includes one or more grippable surfaces to assist gripping of the unit by a human hand.

The unit of the present invention includes a purified water inlet. The inlet may have any suitable size, shape or design, optionally adapted to co-operate with a separate water purification unit as a water source. Optionally the inlet includes a valve such as a solenoid or a non-return valve. Optionally, the purified water inlet is designed to accept a feed or stream of purified water as a purified water inlet.

Optionally, the purified water inlet is flush with an outer surface of the housing.

Optionally, the purified water inlet is a portion of the top of the handheld housing.

Additionally or alternatively, the purified water inlet is located in the base of the handheld housing.

Optionally the purified water inlet comprises a removable or hinged portion or a flap or a portal, optionally which inlet is easily mateable with or locatable in conjunction with, such as on, under, against, abutting, etc., a suitable dispense or point of use or tap of a supply of purified water, such as a water purification apparatus known in the art. Such an arrangement includes being located against the end of a flexible dispense of a water purification apparatus, under a suitable tap or dispense port or portal, or mating with a suitable port or portal in a male-female configuration, optionally including a self-sealing device such as a self-sealing valve on uncoupling.

Sources of purified water for the purified water inlet could be provided by a known water purification apparatus. Water purification apparatus are known in the art, and are generally intended to provide a purified water stream optionally having a conductivity of less than 1 μS/cm, preferably less than 0.1 μS/cm, more preferably less than 0.067 μS/cm, at 25° C. This can be equated to the purified water stream having a resistivity of at least 1 MΩ-cm, preferably at least 10 MΩ-cm, more preferably at least 15 MΩ-cm. Additionally, purity specifications can be made for organic species to content levels of less than 500 ppb of total organic carbon (TOC), preferably less than 50 ppb and bacteria to levels less than 100 colony forming units (cfu) per millilitre, preferably less than 1 cfu/ml.

Such water purification apparatus could be a fixed, permanent or ‘stand alone’ unit, generally only requiring connection to nearby water and electricity supplies to be operable. They are generally units operating in or at a specific location such as in a laboratory. Larger purification apparatus may supply a series of outlet points such as taps at various points within the laboratory.

Thus, the purified water provided to the unit of the present invention is created by the reduction and/or removal of any or one or more of the contaminants and impurities in a water stream, typically a potable water stream, by the one or more water purification devices known in the art able to reduce the ionic, organic and/or bacteria impurities therein.

Optionally, the water purification apparatus is at least partly adapted to mate or complement the water purifying and dispensing unit, such as having complementary housing, and/or complementary mating parts and/or shape in order to wholly or partly support or house the water purifying and dispensing unit with the larger water purification apparatus. The water purification apparatus is able to directly or indirectly be the source of or otherwise provide purified water to the purified water inlet of the water purifying and dispensing unit.

The unit of the present invention includes a further-purified water dispense outlet. The water dispense outlet may have any suitable size, shape and design optionally including a nozzle, and optionally being able to provide a jet and/or non-drip water dispense outlet.

The further-purified water dispense outlet is able to provide water that is further purified after its input into the hand-holdable portable water purifying and dispensing unit by the reduction or removal of at least one or more of the group comprising:

ionic species, organic substances, organic molecules, bacteria and micro-organisms. That is, the further-purified water provided by the unit of the present invention is created by at least some non-mechanical reduction and/or removal, by the one or more water further-purification devices in the housing of any or one or more of the contaminants and impurities in the inlet purified water stream or by the prevention or removal of contamination of the purified water by ionic, organic or bacterial species while entering or being in the portable water purifying and dispensing unit.

Water further-purification devices are known in the art, and are generally intended to provide further-purified and/or ultra-purified water, optionally having a conductivity of less than 1 μS/cm, preferably less than 0.1 μS/cm, more preferably less than 0.067 μS/cm, at 25° C. This can be equated to the further-purified water stream having a resistivity of at least 1 MΩ-cm, preferably at least 10 MΩ-cm, more preferably at least 15 MΩ-cm. Additionally, purity specifications can be made for organic species to content levels of less than 500 ppb of total organic carbon (TOC), preferably less than 50 ppb and bacteria to levels less than 100 colony forming units (cfu) per millilitre, preferably less than 1 cfu/ml

The unit of the present invention may comprise any number of water further-purification components, as well as other devices, parts, lines, etc, including but not limited to one or more of the following: pumps, meters, oxidisers, de-ionisers, valves, sensors, drains, controllers, control units and mechanisms, taps, filters, membranes. Generally, the water further-purification component(s) operate through a controller in the water purification apparatus to control one or more aspects or processes of the water purification. One or more controllers may be located in the unit

The unit of the present invention includes a reservoir. The reservoir may have any suitable size, shape and design able to hold a volume of further-purified water. Optionally, the reservoir has a volume in the range between 100 ml to 2000 ml, more optionally between 200 ml and 1000 ml, such as 300 ml, 400 ml, 500 ml, 600 ml, 700 ml, 800 ml, and 900 ml.

Optionally, the reservoir is at least partly transparent, more optionally wholly or substantially transparent. In this way, the user can see the volume of water being held in the reservoir, and at least estimate or judge the approximate volume thereof prior to use. This allows a user to estimate or judge whether refilling the unit is required prior to use of the unit to dispense further purified water.

Optionally, a part of the reservoir comprises at least a part of the housing. Alternatively, or additionally, a portion of the housing partly, substantially or wholly comprises at least a portion of an outer surface of the reservoir. Optionally, a user is able to hold the unit of the present invention by locating a hand around a part or a portion of the reservoir and another surface part or portion of the housing.

Optionally the housing comprises at least a transparent reservoir outer surface, and at least another non-transparent outer surface.

Optionally the reservoir is wholly or partly detachable so that it can be cleaned as necessary or sanitised in for example an autoclave.

Optionally, the reservoir has a water re-circulation outlet at or near the bottom of the reservoir and a water re-circulation inlet at or near the top of the reservoir.

The reservoir includes an air inlet/outlet to assist and/or allow equalisation of pressure in the reservoir during filling and dispensing. Optionally the air pathway into the reservoir includes one or more apparatus, devices or materials for removing contaminants such as bacteria or carbon dioxide from air entering the reservoir during dispense.

The unit of the present invention includes an internal water re-circulation pathway. The re-circulation pathway occurs within the unit and includes the reservoir.

The unit of the present invention includes at least one internal water re-circulation pump. The or each pump is able to provide the driving force for the passage of water around the internal water re-circulation pathway. The pump may be operated continuously but to save power operation may be intermittent such as 5 minutes per hour and/or on interaction with the unit.

The unit of the present invention includes one or more water further purification devices.

According to one embodiment of the present invention, the one or more water further purification devices are selected from the group comprising: a deionisation device, an electrodeionisation device, a capacitive deionisation device, activated carbon, ion-exchange resins an ultra-violet device, an LED ultra-violet device, an ozone device and a peroxide device. Mechanical filtration such as ultra- or micro-filtration may be further added.

Optionally, one or more of the further-water purification devices are fixed, permanent or otherwise integral with the housing.

Alternatively or additionally, one or more of the further-water purification devices is a consumable device or comprises a consumable portion. A “consumable device” or “consumable portion” as used herein includes a device or portion of a device intended to be recurrently replaced, generally once its use or function has gone beyond a pre-defined parameter, usually time, or has deteriorated beyond a pre-defined level.

A consumable device can include a unit comprising ion-exchange resins, and a consumable portion can comprise ion-exchange resins. Many types and forms of ionic resins are known in the art, sometimes also termed ‘de-ionisers’, including cation exchange resins, anion exchange resins and zeolites. The action and operation of such resins are well known in the art, and they are not further described in detail herein.

In the present invention, at least one further-purification device is located in the internal water recirculation pathway.

Where the unit includes a water re-circulation reservoir inlet, the reservoir inlet may be located at or near the water one or more water further-purification devices. Thus, water re-circulation in the unit passes the water through such water further-purification device.

Optionally, at least one of the or each water further-purification devices is replaceable. This may be on a time or usage basis.

Optionally, the internal recirculation path includes one or more additional water further-purification devices, typically but not exclusively outside the reservoir, and selected from the group comprising: an oxidiser, a deionisation device, an electro-deionisation device, a capacitive deionisation device, activated carbon, ion-exchange resins, an ultra-violet device, an LED ultra-violet device, an ozone device and a peroxide device.

The nature of any additional water purification devices may be the same or different as described for the one or more water further-purification devices as described herein.

One common oxidiser involves the use of ultraviolet light, and the ultraviolet treatment of water for decomposing organic compounds or substances in water is well known in the art. Generally, ultraviolet light is able to decompose many organic compounds and substances that are contained or are residues in generally available water, by oxidising them to form ionic species. Apparatus and instruments for providing suitable ultraviolet light are well known in the art, and typically involve emitting ultraviolet light at one or more specific wavelengths in an area or space in which the water is held or through which the water passes.

Alternatively or additionally oxidising species such as peroxide or ozone may be generated in the water from oxygen dissolved within it. Such oxidising species act on organic molecules to break down any organic molecules, and where the organic molecules are associated with viable species, render the species non-viable.

An oxidiser can be provided as a distinct component having an ultraviolet emitter therein around which the water stream passes from an inlet to an outlet. The purification of water in the present invention may involve one or more oxidisers, being in series, parallel or both. An ultraviolet emitter may be or may include one or more LEDs.

Additionally an ultraviolet emitter, such as an LED, may be located at the dispense outlet or in the line from the recirculation loop to the dispense outlet.

Many types and forms of de-ionisation devices are known in the art, and include, but are not limited to, one or more of the following; ion exchange resins, capacitive deionisation apparatus or units and electro-deionisation apparatus or units. Discharging of waste ions from capacitive deionisation or electro-deionisation may take place in a discontinuous manner such as at a time when the unit is not required to be operable. The action and operation of de-ionisers is well known in the art, and they are not further described in detail herein.

Optionally the unit includes at least one pump, and the or each pump is able to provide the driving force for the dispense of further-purified water from the unit, optionally involving some portion or part of the internal water re-circulation pathway.

Optionally the unit of the present invention includes an internal power supply. The internal power supply may be provided by one or more power sources being the same or different, including but not limited to one or more batteries, in particular one or more rechargeable batteries. Power sources able to provide power within a handheld device are well known in the art, in particular rechargeable batteries, typically recharged by one or more external power sources including direct power leads, or induction devices or the like.

The unit of the present invention may have a dispense mode or other such form of operation, and a recirculation mode. Preferably, the point of dispense involves at least one valve, more preferably operable between a dispense position and a recirculating position. One or more valves may also provide control over the volume and/or rate of flow of the purified water at the dispense.

The dispense may involve the dispense of some or all of the further-purified water in the reservoir.

Operation of further-purification devices such as those that generate oxidising species may be suppressed during a dispense. Operation of powered deionising devices such as capacitive deionisers may be activated during dispense while electrodeionisers may be inactivated so that the resins just deionise the water. In each case, dispense may be followed by subsequent elution of ions after the dispense.

Optionally, the unit includes a user interface. Optionally the user interface includes a display. The interface and/or display may have any suitable size, shape and configuration, and generally comprises one or more display portions and/or cells, able to provide visual information to a user. Such information may include one or more figures and/or parameters concerning the operation of one or more parts or components of the unit. Such information could include one or more readings and/or measurements of a parameter such as purity, conductivity, resistivity, flow, speed, temperature of the water in the reservoir, and/or of one or more of the water further-purification components in the unit.

Optionally, the user interface includes one or more of the group comprising: volumetric dispense, resistivity display, warning indicator, water temperature display, water purity display, power indicator, power warning, water temperature alarm, water level, and water purity alarm.

Optionally, the unit further includes one or more water temperature sensors or one or more water purity sensors, or both.

In another embodiment of the present invention, the unit includes one or more volumetric dispense means. Such means are well known in the art, and allow the unit to dispense a required and/or desired volume of purified water, sometimes repeatably from the dispense point or outlet, such volume generally being pre-set by the user. Methods and apparatus for providing for volumetric dispense are known in the art, and generally include at least one user control for setting and/or controlling the volumetric dispense.

In another embodiment of the present invention, the unit includes a purified water dispense flow control, adapted to provide the user with control of the flow of the purified water at or through the dispense. Such a control may be operative electronically and/or manually.

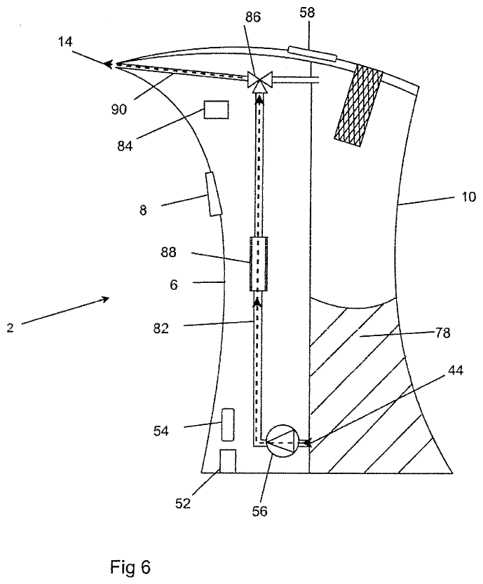

Optionally, the unit has a water dispense operator having haptic feedback. That is, movement of the water dispense operator provides proportional operation of the flow of further-purified water through the dispense point or dispenser, rather than the flow being a function of the valve's operation parameters, or its materials of construction, or other system process parameters such as check valve pressures, pump pressures etc. U.S. Pat. No. 5,925,240, incorporated herein by way of reference, shows in its FIG. 6 an example of a dispense control achievable, wherein the outflow rate can be a direct function of the input. It is possible to select and program the dispense outflow rate as graphically shown in FIG. 6 of U.S. Pat. No. 5,925,240, for example as a sine curve with an initially flat and subsequently steeper rise.

In another embodiment of the present invention, the unit includes one or more physical and/or electronic input controls able to operate or enabled to vary one or more of the variable operations of the unit, usually through one or more internal controllers. That is, at least one process or action of at least one of the water further-purification components in the unit is varyingly operable by the user via one or more of such input controls. The input control(s) may be any activation or switch or control means known in the art such as buttons, dials, potentiometers, etc., as well as combinations thereof.

According to another embodiment of the present invention, one or more of the water purification input controls on the unit is enabled to allow the programming of the water purification apparatus by a user, so as to allow the user to temporarily and/or permanently vary a programmed operation of one or more of the water purification components, such as pump speed, flow, purity, etc.

Optionally, the unit of the present invention is one or more of remotely monitorable, remotely operable and remotely controllable. The unit may include suitable hardware and/or software to allow communication with an independent unit such as a mobile phone, base unit or a service provider, and is able to provide a remote operator with information about the unit, including warnings or alarms as described herein, including low power or low purity readings, and/or remote operation of the unit. Examples include a base unit or mobile phone having a unit battery or unit water purity warning indicator.

According to a second aspect of the present invention, there is provided a water purifying and dispensing assembly comprising a hand-holdable portable water purifying and dispensing unit as described herein and a base stand.

Optionally, in the assembly, the hand-holdable portable water purifying and dispensing unit includes one or more rechargeable batteries, and the base stand includes a battery recharging source. In this way, the base unit can provide a suitable location for recharging a power source in the unit when the unit is not in use.

Optionally, in the assembly, the base stand includes a water input such as a connection, conjunction or mating, so that when the hand-holdable portable water purifying and dispensing unit is placed on the base stand, a connection, conjunction or mating is made with a water input point incorporated in the base stand, such that purified water can enter the portable water purifying and dispensing unit. This water input may be enacted by a water level detection system that is part of the base stand, and/or which is part of the portable water purifying and dispensing unit. Means for level detection are known in the art, and could involve pressure, optical, conductive or ultrasonic sensing and/or sensors.

Purified water may be fed to or recirculated through the base stand from a laboratory water purification apparatus or site supply.

Additionally, technologies that capture contaminants within them may be triggered to elute those contaminants from the assembly while connected to the base stand. This may be as a separate waste line or into the recirculating stream of the laboratory water purification apparatus or site supply.

Optionally, there is provided a water purifying and dispensing assembly comprising a plurality of hand-holdable portable water purifying and dispensing units as defined herein, and a multi-base stand. Optionally, where the hand-holdable portable water purifying and dispensing units include one or more rechargeable batteries, such the multi-base stand includes a corresponding number of battery recharging sources.

Optionally, in such a water purifying and dispensing assembly, the hand-holdable portable water purifying and dispensing units have purified water inputs via purified water connections in the multi-base stand, which includes a corresponding number of purified water connections to the water purifying and dispensing units.

A multi-base stand may be supplied with purified water from a water purification unit through a single feed connection.

Where the hand-holdable portable water purifying and dispensing units have outlet water connections for recirculation or waste streams via connections to the multi-base stand, the multi-base stand may also include a corresponding number of water outlet connections from the water purifying and dispensing units.

A multi-base stand may have a single connection from the multi-base stand for recirculation to the water purification apparatus or for waste or drain.

A base stand or multi-base stand may include water purification technology as described herein to help maintain the purity of the purified water or to prevent re-contamination as it passes through the base or multi-base stand.

The purified water for the water purifying and dispensing unit may be supplied by a water purification apparatus as described herein.

Thus, according to a third aspect of the present invention, there is provided a water purifying and dispensing combination comprising a hand-holdable portable water purifying and dispensing unit as defined herein and a water purification apparatus able to supply purified water to the purified water inlet of the hand-holdable portable water purifying and dispensing unit.

Optionally, the water purification apparatus includes one or more battery recharging sources and a purified water recirculation pathway able to co-operate with one or more hand-holdable portable water purifying and dispensing units.

The housing of such a water purification apparatus may be adapted to match or complement one or more parts or portions of the water purifying and dispensing unit, such as having integral and/or moulded ports or portals as part of the housing, to accommodate suitable or the required mating of the water purifying and dispensing unit therewith.

Alternatively, or additionally, the combination as defined in the present invention includes a base stand as defined herein. Thus, the present invention can relate to the combination of both the water purifying and dispensing unit, a complementary base stand, and a complementary water purification apparatus. Such a base stand may be integral or separate from the water purification apparatus. Such a base stand may include one or more electrical pathways and water pathways with the water purification apparatus.

Optionally such a base stand includes a re-circulation loop or pathway for purified water from the water purification apparatus and returning thereto, which re-circulation pathway may be able to provide purified water to one or a plurality of water purifying and dispensing units, through the base stand. Any re-circulation loop from the water purification apparatus may be combined with the recirculation loop within the hand-holdable portable water purifying and dispensing units to form a combined flow path.

Such a re-circulation pathway can include returning non-required purified water back to the water purification apparatus to maintain its water quality by new or repeat water purification processes within the water purification apparatus.

Such a base stand may include a first pathway or connection between the water purification apparatus and the base stand to supply purified water thereto, and a second connection or pathway between the base stand and the water purification apparatus.

The skilled man can see that the base stand and/or the water purification apparatus can be partly, substantially or fully co-ordinated with the water purifying and dispensing unit to provide a co-operating arrangement in the form of a ‘docking station’ or ‘support unit’, that can maintain the required power and/or purified water within a water purifying and dispensing unit when not in use. The user can therefore have always have available a volume of further-purified water in a portable unit ‘ready to use’.

According to a fourth aspect of the present invention, there is provided a method of providing purified water comprising at least the steps of:

(a) filling a hand-holdable portable water purifying and dispensing unit as defined herein with purified water through the purified water inlet;
(b) recirculating the purified water through the internal water recirculation pathway to provide further-purified water; and
(c) operating the unit to dispense the further-purified water through the purified water dispense outlet.

According to a fifth aspect of the present invention, there is provided a method of recharging and/or refiling a hand-holdable water purifying and dispensing unit as defined herein using a base stand as defined herein comprising at least the steps of:

(a) locating the water purifying and dispensing unit on the base stand;
(b) filling the portable water purifying and dispensing unit with purified water from the base stand through the purified water inlet, and/or recharging the portable water purifying and dispensing unit from the base stand.

The present invention encompasses all combinations of various embodiments or aspects of the invention described herein. It is understood that any and all embodiments of the present invention may be taken in conjunction with any other embodiment to describe additional embodiments of the present invention.

Furthermore, any elements of an embodiment may be combined with any and all other elements from any of the embodiments to describe additional embodiments.

Embodiments of the present invention will now be described by way of example only, and with reference to the accompanying diagrammatic drawings in which:

FIG. 1 is a side view of a portable water purifying and dispensing unit according to one embodiment of the present invention, and a water purifying and dispensing assembly according to another embodiment of the present invention;

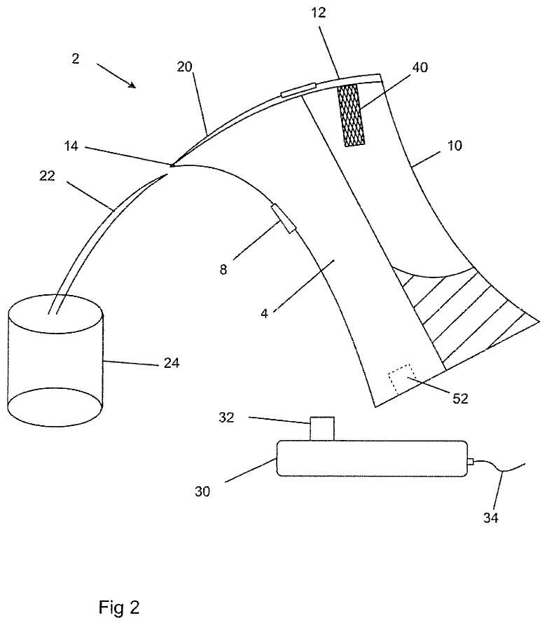

FIG. 2 is a view of the unit and assembly shown in FIG. 1 in a dispense configuration;

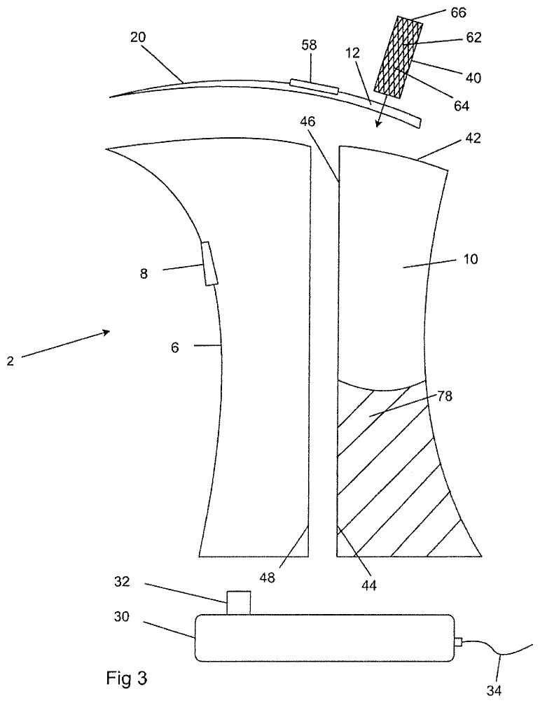

FIG. 3 is an exploded view of parts of the unit and assembly shown in FIG. 1;

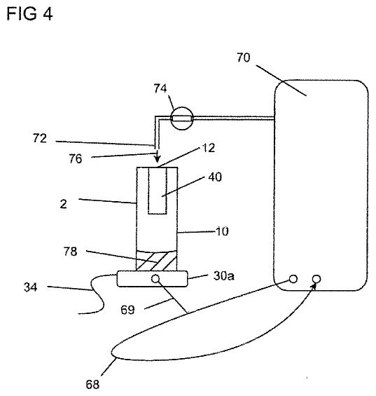

FIG. 4 is a view of the unit and base stand in FIG. 1, the unit being filled from a water purification apparatus to show further embodiments of the present invention;

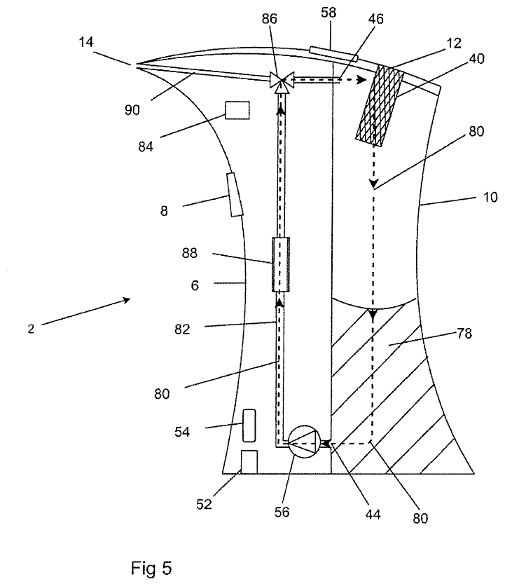

FIG. 5 is a side cross-sectional view of the unit in FIG. 1 in a recirculation configuration;

FIG. 6 is a side cross-sectional view of the unit in FIG. 1 in a dispense configuration;

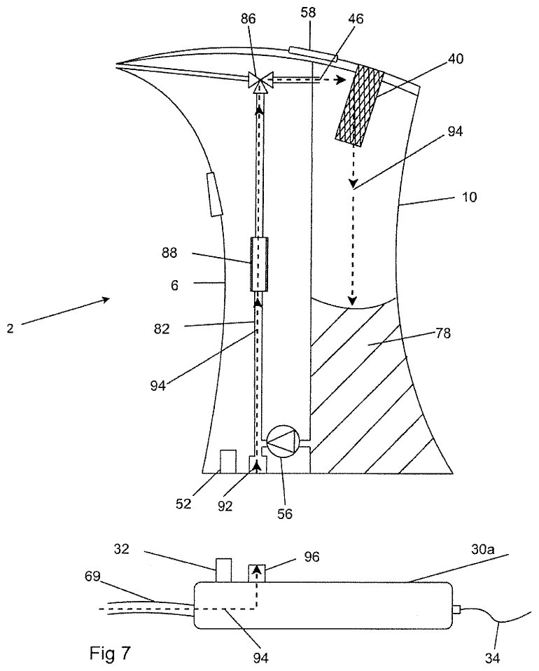

FIG. 7 is a side cross-sectional view of the unit in FIG. 1 with a water inlet from the base; and

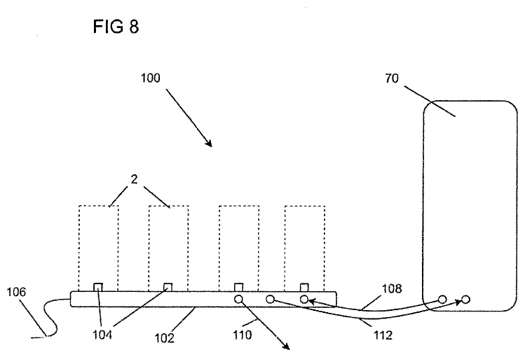

FIG. 8 is a perspective view of a second water purifying and dispensing assembly and combination according to further embodiments of the present invention.

Referring to the drawings, FIGS. 1 and 2 show a portable water purifying and dispensing unit 2. The unit 2 comprises a handheld housing 4, having a relative ‘front’ or ‘forward’ non-transparent portion 6 relative to the dispense function, and within which there is located a dispense operator 8. The unit 2 also includes a reservoir 10, a purified water inlet 12 and a further-purified water dispense outlet 14.

FIGS. 1 and 2 show the handheld housing 4 comprising an elongate body 18 having a substantially flat base 16, such that the unit 2 can stand in a relative ‘upstanding position’ on a flat surface such as a laboratory bench, and an upstanding reservoir 10 and a top surface 20.

The shape and configuration of the base 16 of the unit 2 may be designed or adapted to match or complement a base stand as described further below. The base 16 may also include one or more parts or portions adapted to match with or be complementary to one or more parts and portions of a base stand or a water purification apparatus, including a charging source and/or a purified water inlet.

The top surface 20 includes a purified water inlet 12. The top surface 20 extends laterally from the elongate body 18 and the extension returns to join the elongate body. Optionally, the top surface 20 extends sufficiently laterally from the elongate body 18 such that the further-purified water dispense outlet 14 is beyond a hand of a user located around the elongate body 18 in use. The further-purified water dispense outlet 14 is located at the end of the lateral extension.

FIG. 2 shows the unit 2 of present invention in use, excluding for clarity purposes a user's hand around the elongate body 18. FIG. 2 shows operation of the unit 2 by pressure from a user's hand on the dispense operator 8 to dispense a portion of water 22 from the further-purified water dispense outlet 14 into a beaker 24, described in further detail hereinafter.

FIGS. 1 and 2 also show a base stand 30. The base stand 30 has a substantially flat surface complementary to the substantially flat base 16 of the unit 2, with an upstanding induction power supply point 32 to locate with an inductive charging locator 52 located in the unit 2, and an optionally detachable power lead 34, to a supply able to provide power to the base unit 30. Similar upstanding connection points (not shown) could be used for an alternative purified water input and/or recirculation water or waste output.

The base unit 30 and the portable water purifying dispensing unit 2 together form a water purifying and dispensing assembly according to another embodiment of the present invention.

The unit 2 shown in FIGS. 1 and 2 has an overall handheld housing 4 comprising the non-transparent portion 6 and part of the reservoir 10, which together provide an outer surface designed to be grippable by a human hand. The unit 2 is designed to locate the dispense operator 8 where a user may locate a moveable portion of the hand, such as one or more parts of the finger, in the manner of a trigger or button known in the art.

FIG. 2 also shows a water further-purification device 40 located beyond the purified water inlet 12 as described in more detail hereinafter.

FIG. 3 is an exploded view of the parts or portions of the unit 2 shown in FIGS. 1 and 2. FIG. 3 shows the reservoir 10 formed as a single component having an open top 42, a water re-circulation outlet 44 as a first aperture at or near the bottom of reservoir 10, and a water re-circulation inlet 46 as a second aperture at or near the top of the reservoir 10.

FIG. 3 shows the non-transparent portion 6 having an upstanding back wall 48, which is optionally formed separately and conjoined with the remainder of the non-transparent portion 6 after the location of one or more components within the internal space of the non-transparent portion 6. The back wall 48 has upper and lower apertures that are complementary to the water re-circulation inlet 46 and water re-circulation outlet 44 of the reservoir 10.

Alternatively the reservoir 10 may have an outlet in its base to connect with a location in an elongated lower portion of the non-transparent portion 6 and/or may have an inlet that passes into the reservoir through the top section and the water further-purification device 40.

Within the non-transparent portion 6 is located at least an internal power supply being one or more rechargeable batteries 54, and a pump 56.

FIG. 3 also shows the top surface 20 having the purified water inlet 12, and a user interface 58. The user interface 58 includes at least one display portion and/or cells, able to provide at least visual information to a user and optionally one or more user-programmable operations or functions. Such information could include one or more readings and/or measurements of a parameter such as amount, purity, conductivity, resistivity, dispense flow, dispense speed, temperature of the water within the unit 2, and/or monitoring of one or more of the water further-purification components in the unit. The user interface may have a touch screen or other mode of user input.

Optionally, the user interface 58 also includes one or more of the group comprising: volumetric dispense, accumulated dispense volume, resistivity display, one or more warning indicator, water temperature display, water purity display, water temperature alarm, and water purity alarm.

One or more of such measurements and/or readings can be provided by one or more measuring devices, units or the like within the unit 2. Optionally, the unit 2 therefore includes one or more of water temperature sensors, water quantifying sensors or one or more water purity sensors. Sensors able to provide amount, temperature and/or water purity measurements are known in the art, and such measurements can be provided to an internal controller described hereinafter.

The present invention is not limited by the number, type or function of the visual information, aural information, or operations available to the user through the user interface 58. Optionally, these include at least a visual water purity reading, a water temperature reading, a battery power reading, and a conductivity reading. Such readings may be absolute or relative. Thus, for example, a water purity reading may describe a conductivity measurement of “>18 MΩ-cm” or “18.2 MΩ-cm”.

The user display 58 may be constantly visible, or may be readable upon operation by a user. The user display 58 may include information in relation to the user or the known or expected use of the unit 2

Optionally, the user interface 58 provides a water purity warning as a visual indicator, in conjunction with an aural warning, or both. In this way, the user is notified when at least one of the one or more water further-purification devices is either no longer functioning correctly, or is exhausted of its purification ability, or other non-functioning situation. For example, where the unit 2 includes a replaceable water further-purification device, a water purity warning at the user interface 58 could indicate to the user to replace the water further-purification device, optionally in good time before exhaustion of the purification ability of the water further-purification device.

FIG. 3 also shows in more detail a water further-purification device 40. The purification device 40 comprises an outer perforated housing 62, within which is securely located ion-exchange resin 64. The purification device 40 is shaped so that at least the majority of the body 62 passes through the purified water inlet 12, and a suitable lip or edge at the top of the body 62 holds the purification device 40 in a suspended position below the purified water inlet 12 as shown in FIG. 2, and as shown hereinafter in FIGS. 5 and 6. The top of the further-purification device 40 includes an air filter 66 containing media to remove bacteria and/or carbon dioxide from the air entering the reservoir during dispense that would otherwise reduce the quality of the water in the reservoir 10.

Alternatively the air filter 66 may be located in another section of the top surface 20.

FIG. 3 also shows the base unit 30 and the end of a power lead 34 able to be plugged into the base unit 30.

FIG. 4 shows the unit 2 alongside a stand-alone water purification apparatus 70. The water purification apparatus 70 typically has a normal, potable or ‘mains’ water supply or water supply inlet, and includes one or more water purification apparatus, units or devices, to purify its inlet water stream to create a source of purified water stream available to the unit 2.

The purified water stream provided by the water purification apparatus 70 preferably has a conductivity of less than 1 μS/cm, preferably less than 0.1 μS/cm, more preferably less than 0.067 μS/cm, at 25° C.

In one arrangement, the purified water is provided to the unit 2 through a dispense point of use 72 having a suitable tap 74. The point of use 72 and tap 74 may be a conventional arrangement or dedicated to match or complement the unit 2. In use, operation of the tap 74 supplies a stream of purified water 76 through the purified water inlet 12 of the unit 2, and so through the water further-purification device 40, and into the reservoir 10 to provide a volume of further-purified water 78 in the reservoir 10. By locating the water further-purification device 40 in a suspended position below the purified water inlet 12, the purified water stream 76 applied from the water purification apparatus 70 undergoes further-purification upon its entry into the unit 2, such that the volume of further-purified water 78 is immediately available for dispense by a user if required.

In an alternative arrangement, the purified water is provided to the unit 2 through a recirculation loop 68 extending from the water purification apparatus 70, from which purified water can be taken off using appropriate valves. This has the advantage that the purified water entering the unit 2 does not pass through the atmosphere and does not thereby collect or attract any impurities.

Optionally, the embodiment of the present invention shown in FIG. 4 includes a base stand 30a being similar to the base stand 30 discussed hereinbefore, and the purified water provided to the unit 2 from the water purification apparatus 70 is provided either by having a re-circulation pathway or loop passing through the base stand 30a, or by having a dedicated inlet line 69 being provided from the re-circulation loop 68 into the base stand 30a.

The base stand 30a and/or the unit 2 may include one or more sensors able to determine when the input of purified water into the unit 2 is at a desired or otherwise maximum level, and to close or otherwise disengage a suitable valve or the inlet or the inlet portal, to prevent further purified water in the re-circulation loop 68 passing into the unit 2.

Whilst some of the further-purified water 78 in the unit 2 may be desired for immediate use, it is typical that a user wishes to have a reservoir of ‘ultra-purified’ water available at one or more future times or periods where the user is located or working, which may be at a location remote from, and not physically tied to, a source of purified water such as the water purification apparatus 70. This is similar to the provision and use of ‘wash bottles’ in a laboratory or similar research or high-purity environments. Wash bottles are known in the art as a simple plastic bottle formed of a squeezable plastic material, which can be filled from a suitable water source, often a water purification apparatus or the like, and which is located by a user at or near their workbench or other place of work or workstation, to be immediately available for dispense through a suitable spout or tube, when such water is required during the course of the work.

However, water that is held in any reservoir, sometimes also termed ‘standing water’, loses its purity over time. For some grades of water such as ‘mains water’, and over some periods of time, this is often not critical. However, it is the nature of ‘ultra-purified’ water that its ultra-purified quality can diminish over even short periods of time.

As shown in FIG. 5, the unit 2 of the present invention includes an internal water re-circulation pathway 80. The pathway 80 comprises the passage of water in a re-circulation path or loop. Without limitation thereto, the path or loop may start with the volume of further-purified water 78 in the reservoir 10. Motion of the further-purified water 78 can be provided by the pump 56 operating within a passage of tubing 82 within the non-transparent portion 6.

Thus, the internal water re-circulation pathway 80 comprises, in order but with no definite starting point, the passage of the further-purified water 78 through the water re-circulation outlet 44 of the reservoir 10 and into the tubing 82, through the pump 56, out of the tubing 82 through the water re-circulation inlet 46, and back into the reservoir 10.

The reservoir water re-circulation inlet 46 is located at or near the water further-purification device 40, such that the passage of water therefrom passes across or through the water further-purification device 40, such that water passed through the water further-purification device 40 is further purified prior to becoming or returning to the volume of further-purified water 78 in the reservoir 10. In this way, the unit 2 is able to maintain a reservoir of further-purified water, generally having a conductivity of less 0.1 μS/cm, preferably less than 0.067 μS/cm, at 25° C., which is immediately available for dispense and use.

Alternatively or additionally, the unit 2 includes a fixed or permanent further-purified device such as an EDI unit or similar, within the path of the internal water re-circulation pathway 80 to further purify the water prior to dispense and use.

FIG. 5 also shows the user display 58, a controller 84, the dispense operator 8, and the one or more rechargeable batteries 54. The one or more rechargeable batteries 54 provide power to all the electric components in the unit 2, such as the pump 56, the display 58, and EDI or similar, and the controller 84, in a manner known in the art: and all these components are connected to the controller 84 in a manner known in the art.

FIG. 5 also shows an operable 3-way valve 86 within the pathway of the tubing 82 at or near the top of the unit 6. Alternatively a T-junction with one or more 2 way valves could be used equivalent to the 3 way valve.

FIG. 5 also shows an alternative location for the, or an additional, water further purification device, 88. This may be a device for removing inorganic molecules such as ion exchange resin, and/or an electrodeionisation unit or capacitive deionisation unit; and/or for removing organic molecules such as activated carbon, and/or a UV irradiation device such as by UV-LED, and/or peroxide or ozone generation; or for rendering bacteria non-viable by UV irradiation, or peroxide or ozone oxidation; including any combination of these devices

It is desired to have at least one device for reducing and/or removing inorganic molecules, and at least one device to reduce and/or remove organic molecules or render bacteria non-viable.

FIG. 5 shows the unit 2 acting in a re-circulation mode. Recirculation may be started by any interaction with the unit 2, such as movement of the unit 2, or by pressing of the dispense operator 8, or action with the user interface 58. Additionally or alternatively, recirculation may be initiated on a timed basis such as for 10 minutes every hour, to maintain the purity of the water 78 in the unit.

FIG. 6 shows the unit 2 acting in a dispense mode, wherein operation of the dispense operator 8 by a portion of a user's hand (not shown), is signalled to the controller 84 to switch the 3way valve or equivalent 86 to pass the further-purified water 78 through a dispense tubing 90 towards the further-purified water dispense outlet 14. The form of the dispense may be controllable in one or more ways. In one way, the dispense operator 8 has haptic feedback, such that the degree of operation of the dispense operator 8 relates to the flow and/or rate of dispense at the dispense outlet 14.

The user interface 58 and controller 84 may include one or more programmable functions or programmes, such that the user can program through the interface a particular form or arrangement of water dispense, such as a fixed volumetric dispense of a fixed volume, such as 10 ml, 50 ml, or 100 ml, etc. Dispense of the further-purified water 78 is provided by operation of the pump 56, and the passage of the further-purified water 78 through the water purification outlet 44 of the reservoir 10, and through some of the tubing 82 previously described herein.

The controller 84 may include communication with other devices by any known protocol such as Bluetooth. This communication can be used to initiate recirculation, determine the status of any further purification devices, or to view or analyse operational data.

FIG. 7 shows unit 2 being filled with purified water through the base stand 30a. Unit 2 and base stand 30a are shown apart for clarity of parts but to operate would be conjoined. Purified water passes through tubing 69 into the base stand 30a through which it is directed to the base water outlet 96. In operation this is mated with the purified water inlet 92 of the unit 2 and purified water is allowed to pass into the unit 2. This water may be passed as a fill stream 94 through the water further purification devices 88, 40 prior to its reaching the reservoir 10 or may be passed directly thereto. Sensors in the unit 2, such as, for example, pressure sensors, or in the base stand 30a, such as, for example, load sensors, may detect the amount of water 78 in the reservoir 10 and stop the fill process by a valve in the base stand 30a or elsewhere or via operation of the purified water source. A self sealing valve in the unit's purified water inlet 92 prevents leakage of water on removal of the unit 2 from the base stand 30a.

FIG. 8 shows a second water purifying and dispensing assembly 100 according to another embodiment of the present invention, comprising a plurality of portable water purifying and dispensing units 2 as defined herein, and a multi-base stand 102, optionally located next to a water purification apparatus 70 as described herein. Each of the units 2 can be located on a suitable power recharging source 104 in a manner described herein, and the multi-base 102 can be powered by a suitable power lead 106.

The second assembly 100 shown in FIG. 8 provides a location for a number of portable water purifying and dispensing units 2. The units are able to be power-charged at a suitable single location through a single multi-base 102, and optionally able to be filled with purified water from the water purification apparatus 70 by a recirculation loop based on an inlet pathway or tube 108 from the water purification apparatus 70 into and through the multi-base 102. Where desired, recirculating water may be returned to the water purification apparatus 70 via a return pathway or tube 112. The recirculation loop from the water purification apparatus 70 may be combined with the recirculation loop within the portable water purifying and dispensing unit 2 to form a combined flow path. Any waste water from the further purification can be passed to a suitable drain through tube(s) 110 from the multi-base 102.

The second assembly 100 allows for multiple portable water purifying and dispensing units and allows there to be units ready for use by a user or a multiple of users.

It will be appreciated that although specific embodiments of the invention have been described herein for the purposes of illustration, various modifications may be made without deviating from the spirit of the scope of the invention.

1. A hand-holdable portable water purifying and dispensing unit comprising at least a housing, a purified water inlet, a further-purified water dispense outlet, a dispense operator, a reservoir, one or more water further-purification devices, and an internal water recirculation pump and pathway, said pathway including the reservoir and the one or more water further-purification devices.

2. A unit as claimed in claim 1 wherein the reservoir has a volume in the range 100 ml to 2000 ml.

3. A unit as claimed in claim 1 wherein the reservoir is at least partly transparent.

4. A unit as claimed in claim 1 wherein the purified water inlet includes a self-sealing valve.

5. A unit as claimed in claim 1 wherein the one or more further-water purification devices are selected from the group comprising: a deionisation device, an electrodeionisation device, a capacitive deionisation device, activated carbon, ion-exchange resins, an ultra-violet device, an LED ultra-violet device, an ozone device and a peroxide device.

6. A unit as claimed in claim 1 wherein the purified water inlet includes one or more water further-purification devices.

7. A unit as claimed in claim 6 wherein the water further-purification device includes one or more ion-exchange resins.

8. A unit as claimed in claim 1 wherein one or more of the further-water purification devices are integral with the housing.

9. A unit as claimed in claim 1 wherein one or more of the further-water purification devices is a consumable device or comprises a consumable portion.

10. A unit as claimed in claim 1 wherein the further-purified water dispense outlet is a jet and/or non-drip water dispense outlet.

11. A unit as claimed in claim 1 wherein the reservoir has a water recirculation outlet at or near the bottom of the unit and a water recirculation inlet at or near the top of the unit.

12. A unit as claimed in claim 11 wherein the water recirculation reservoir inlet is at or near to the one or more water further-purification devices.

13. A unit as claimed in claim 1 wherein the internal recirculation path includes one or more additional water further-purification devices selected from the group comprising: an oxidiser, a deionisation device, an electrodeionisation device, a capacitive deionisation device, activated carbon, an ultra-violet device, ion-exchange resins, an LED ultra-violet device, an ozone device and a peroxide device.

14. A unit as claimed in claim 1 wherein the housing comprises a hand-holdable elongate body having at least partly flat base, an upstanding reservoir, a top part or surface having the purified water inlet, and a further-purified water dispense outlet extending laterally from the body.

15. A unit as claimed in claim 1 able to provide and dispense ultrapure water having a resistivity of >15 MΩ-cm.

16. A unit as claimed in claim 1 including an internal power supply.

17. A unit as claimed in claim 16 wherein the power supply comprises one or more rechargeable batteries.

18. A unit as claimed in claim 1 further comprising a user interface.

19. A unit as claimed in claim 18 wherein the user interface includes one or more of the group comprising: volumetric dispense, resistivity display, warning indicator, water temperature display, water purity display, power indicator, power warning, water temperature alarm and water purity alarm.

20. A unit as claimed in claim 1 further including one or more water temperature sensors or one or more water purity sensors, or both,

21. A unit as claimed in claim 1 having a water dispense operator having haptic feedback.

22. A water purifying and dispensing assembly comprising a hand-holdable portable water purifying and dispensing unit as claimed in claim 1 and a base stand.

23. An assembly as claimed in claim 22 wherein the hand-holdable portable water purifying and dispensing unit includes one or more rechargeable batteries, and the base stand includes a battery recharging source.

24. An assembly as claimed in claim 22 wherein the hand-holdable portable water purifying and dispensing unit includes a purified water recirculation pathway, and the base stand and the hand-holdable portable water purifying and dispensing unit include a purified water inlet able to co-operate with the purified water recirculation pathway.

25. An assembly as claimed in claim 1 wherein the base stand is a multi-base stand able to accommodate a plurality of hand-holdable portable water purifying and dispensing units.

26. An assembly as claimed in claim 25 wherein the multi-base includes a plurality of battery recharging sources and a plurality of purified water inlets.

27. A water purifying and dispensing combination comprising a hand-holdable portable water purifying and dispensing unit as defined in claim 1 and a water purification apparatus able to supply purified water to the purified water inlet of portable water purifying and dispensing unit.

28. A combination as claimed in claim 27 wherein the water purification apparatus includes one or more battery recharging sources and a purified water recirculation pathway able to co-operate with one or more hand-holdable portable water purifying and dispensing units.

29. A combination as claimed in claim 27, and further including a base stand.

30. A combination as claimed in claim 29 wherein the base stand includes a recirculation pathway for purified water from the water purification apparatus.

31. A method of providing purified water comprising at least the steps of:
(a) filling a hand-holdable portable water purifying and dispensing unit as defined in claim 1 with purified water through the purified water inlet;
(b) recirculating the purified water through the internal water recirculation pathway to provide further-purified water; and
(c) operating the unit to dispense the further-purified water through the purified water dispense outlet.

32. A method of recharging and/or refiling a water purifying and dispensing unit as defined in claim 1 using a base stand comprising at least the steps of:
(a) locating the hand-holdable potable water purifying and dispensing unit on the base stand;
(b) filling the hand-holdable portable water purifying and dispensing unit with purified water from the base stand through the purified water inlet, and/or recharging the portable water purifying and dispensing unit from the base stand.
